(19) United States
(12) Patent Application Publication
(10) Pub. No.: US 2017/0345171 A1
(43) Pub. Date: Nov. 30, 2017

(54) METHOD FOR MEASURING DEPTH OF FIELD AND IMAGE PICKUP DEVICE USING SAME

(71) Applicant: PRIMAX ELECTRONICS LTD., Taipei (TW)

(72) Inventor: Jui-Ting Chien, Taipei (TW)

(21) Appl. No.: 15/257,698

(22) Filed: Sep. 6, 2016

(30) Foreign Application Priority Data
May 27, 2016 (TW) 105116773

(51) Int. Cl. G06T 7/50; H04N 5/232; G01B 11/14; G01B 11/22; G06T 7/557; G06T 7/55

(52) U.S. Cl. CPC G06T 7/50; G06T 7/557; G06T 7/55; G01B 11/14; G01B 11/22; H04N 5/23229

(57) ABSTRACT

A method for measuring a depth of field is provided. A single optical lens module is used to capture an image. The depth-of-field data of each imaging area of the image is acquired according to plural first incident light portions and plural second incident light portions of the image. Then, the plural local depth-of-field data are combined as an overall depth-of-field data of the image. Moreover, an image pickup device using the method is provided. For acquiring the depth-of-field data, it is not necessary to install plural optical lens modules. Consequently, the fabricating cost is reduced, and the volume of the image pickup device is decreased.

### FIELD OF THE INVENTION

The present invention relates to an optical imaging field, and more particularly to a method for measuring a depth of field and an image pickup device using the method.

### BACKGROUND OF THE INVENTION

Recently, with the development of electronic industries and the advance of industrial technologies, various electronic devices are designed toward small size, light weightiness and easy portability. Consequently, these electronic devices can be applied to mobile business, entertainment or leisure purposes whenever or wherever the users are. For example, various image pickup devices are widely used in many kinds of fields such as smart phones, wearable electronic devices, aerial imaging devices or any other appropriate electronic devices. Since the image pickup devices are small and portable, the users can take the image pickup devices to capture images and store the images at any time according to the users' requirements. Alternatively, the images can be uploaded to the internet through mobile networks. In other words, these electronic devices not only have important commercial values but also provide more colorful lives to people. With the improvement of the living quality, people's demands on the images are gradually increased. For example, many people are willing to acquire the images with higher quality or more imaging effects.

FIG. 1 schematically illustrates the appearance of an existing smart phone. The smart phone 9 comprises two optical lens modules 91 and 92, which are in parallel with each other. These two optical lens modules 91 and 92 can shoot the scene at different angles. After two images are captured by the two optical lens modules 91 and 92, the two images are analyzed and calculated. Consequently, a stereoscopic image with the depth-of-field data is obtained. Nowadays, the smart phone 9 with two optical lens modules 91 and 92 is produced by HTC Corporation, Sony Corporation, LG Corporation, Huawei Technologies Co. Ltd, or the like. The technologies of using two optical lens modules 91 and 92 to obtain the depth-of-field data are well known to those skilled in the art, and are not redundantly described herein.

However, the smart phone with two optical lens modules to obtain the depth-of-field data of the image still has following drawbacks. Firstly, the additional optical lens module and the accessories increase the fabricating cost. Moreover, because of the increased volume of the additional optical lens module and the accessories, it is difficult to develop the smart phone with small size, light weightiness and easy portability. In other words, the conventional method for acquiring the depth-of-field data of the image needs to be further improved.

### SUMMARY OF THE INVENTION

An object of the present invention provides a method for measuring a depth of field. According to the method of the present invention, a single optical lens module is used to capture the image and acquire the depth-of-field data of the image through plural phase detection pixel groups of the image.

Another object of the present invention provides an image pickup device. The image pickup device uses a method for measuring a depth of field. Consequently, the fabricating cost is reduced, and the image pickup device meets the requirements of small size, light weightiness and easy portability.

In accordance with an aspect of the present invention, there is provided a method for measuring a depth of field. The method includes the following steps. Firstly, an image is acquired. The image contains plural phase detection pixel groups. The plural phase detection pixel groups include plural first incident light portions and plural second incident light portions, respectively. Then, the plural first incident light portions are collected as a first pattern, and the plural second incident light portions are collected as a second pattern. The first pattern has plural first blocks corresponding to plural imaging areas of the image. The second pattern has plural second blocks corresponding to the plural imaging areas of the image. Then, a phase difference between each first block and the corresponding second block and phase differences between the first block and plural test blocks are acquired, and a local depth-of-field data of the imaging area of the image corresponding to the lowest phase difference of the plural phase differences is acquired. The plural test blocks are partially overlapped with the corresponding second block or located near the corresponding second block. Afterwards, the plural local depth-of-field data are combined as an overall depth-of-field data of the image.

In accordance with another aspect of the present invention, there is provided an image pickup device. The image pickup device includes a lens module, a sensing element, an image segmentation unit and a computing unit. After light beams passing through the optical lens module are projected on the sensing element, the sensing element senses the light beams and acquires an image. The sensing element includes plural phase detection unit groups. The image contains plural phase detection pixel groups corresponding to the plural phase detection unit groups. The plural phase detection pixel groups comprise plural first incident light portions and plural second incident light portions, respectively. The image segmentation unit is connected with the sensing element. The image segmentation unit collects the plural first incident light portions as a first pattern and collects the plural second incident light portions as a second pattern. The first pattern has plural first blocks corresponding to plural imaging areas of the image. The second pattern has plural second blocks corresponding to the plural imaging areas of the image. The computing unit is connected with the image segmentation unit. The computing unit acquires a phase difference between each first block and the corresponding second block and phase differences between the first block and plural test blocks, acquires a local depth-of-field data of the imaging area of the image corresponding to the lowest phase difference of the plural phase differences, and combines the plural local depth-of-field data as an overall depth-of-field data of the image. The plural test blocks are partially overlapped with the corresponding second block or located near the corresponding second block.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the appearance of an existing smart phone;

FIG. 2 is a schematic functional block illustrating an image pickup device according to an embodiment of the present invention;

FIG. 3 schematically illustrates a sensing element of the image pickup device of FIG. 2;

FIG. 4 is a flowchart illustrating a method for measuring a depth of field according to an embodiment of the present invention;

FIG. 5 schematically illustrates an image obtained in the step S1 of the method of FIG. 4;

FIG. 6A schematically illustrates a first pattern in the method of FIG. 4; and

FIG. 6B schematically illustrates a second pattern in the method of FIG. 4.

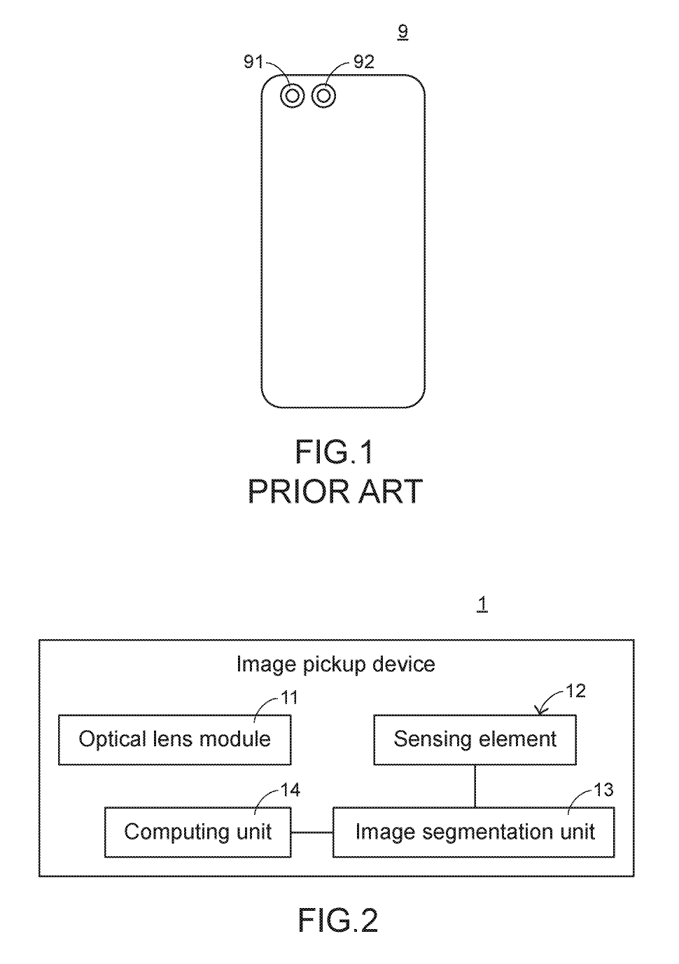

### DETAILED DESCRIPTION OF THE PREFERRED EMBODIMENT

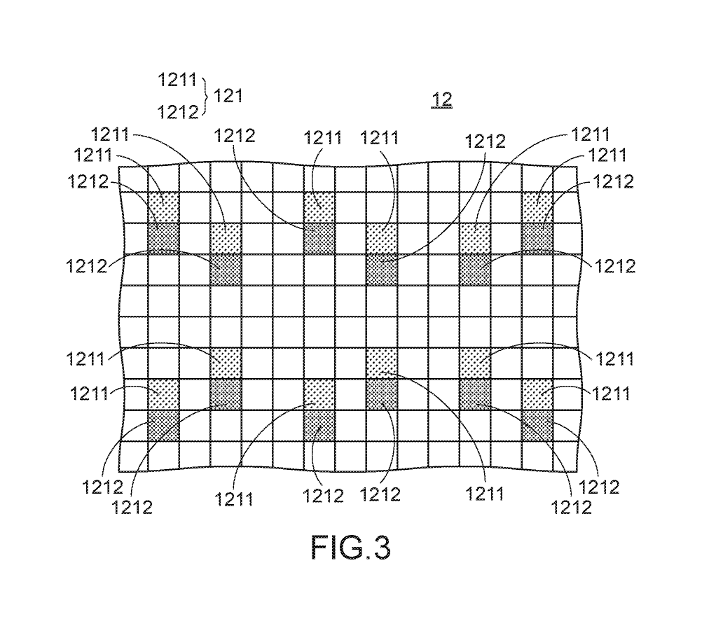

Hereinafter, the components of an image pickup device of the present invention will be illustrated with reference to FIGS. 2 and 3. FIG. 2 is a schematic functional block illustrating an image pickup device according to an embodiment of the present invention. FIG. 3 schematically illustrates a sensing element of the image pickup device of FIG. 2. The image pickup device 1 comprises an optical lens module 11, a sensing element 12, an image segmentation unit 13 and a computing unit 14. The image segmentation unit 13 is connected between the sensing element 12 and the computing unit 14. After the light beams passing through the optical lens module 11 are projected on the sensing element 12, an image is acquired by the sensing element 12. In this embodiment, the sensing element 12 comprises plural phase detection unit groups 121. Each phase detection unit group 121 comprises a first incident light phase detection unit 1211 and a second incident light phase detection unit 1212.

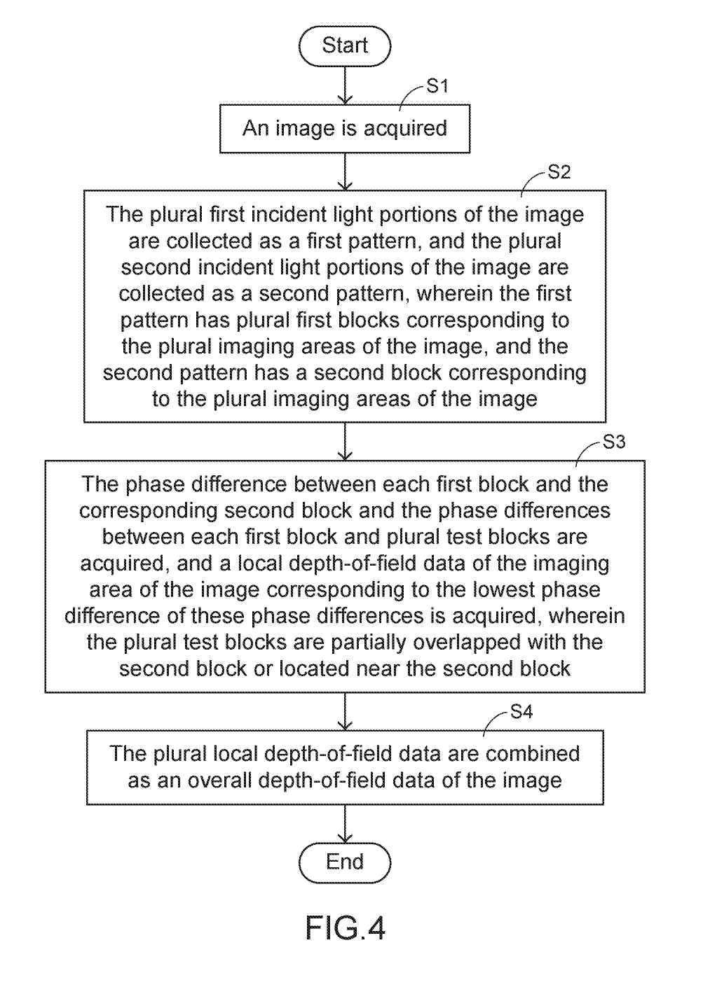

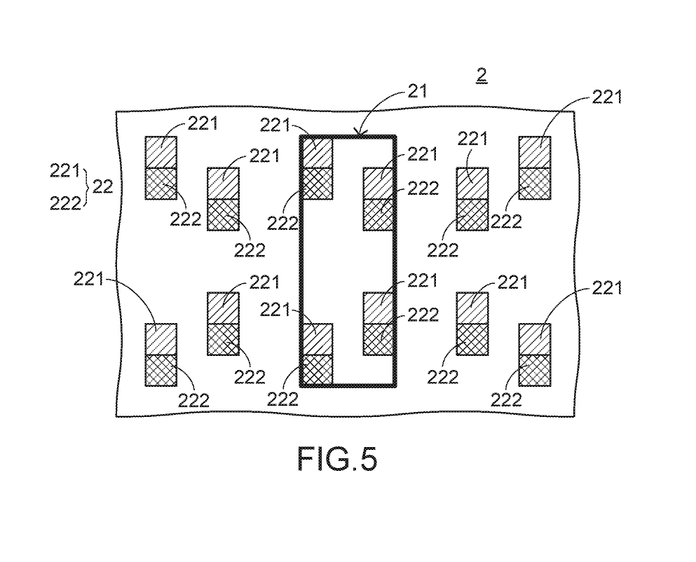

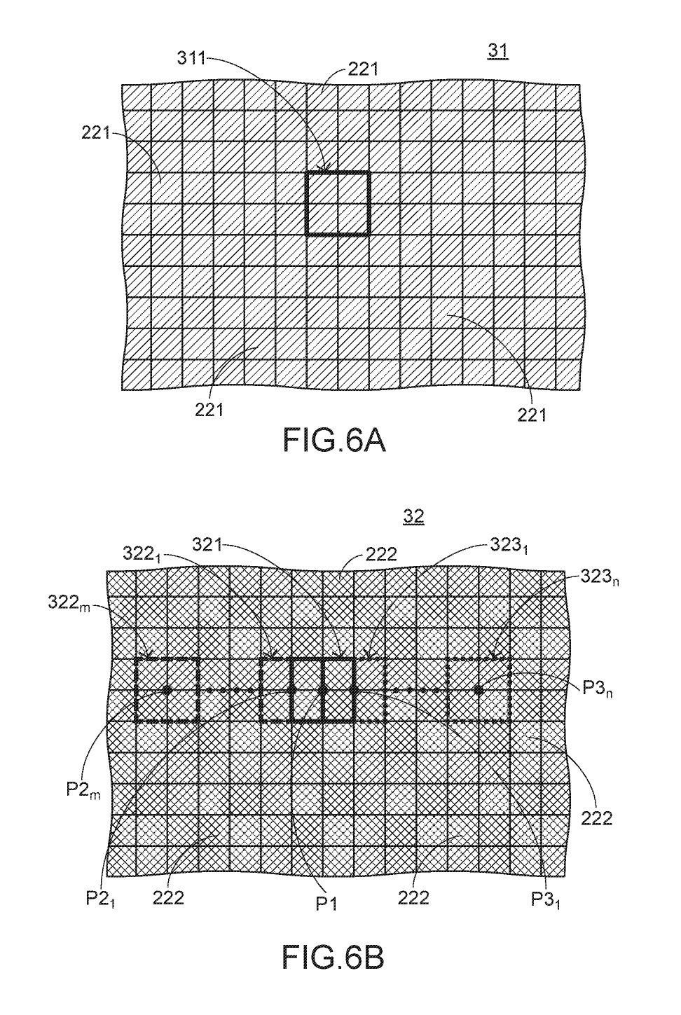

Hereinafter, a method for measuring a depth of field by the image pickup device will be illustrated with reference to FIGS. 4, 5, 6A and 6B. FIG. 4 is a flowchart illustrating a method for measuring a depth of field according to an embodiment of the present invention. FIG. 5 schematically illustrates an image obtained in the step S1 of the method of FIG. 4. FIG. 6A schematically illustrates a first pattern in the method of FIG. 4. FIG. 6B schematically illustrates a second pattern obtained in the method of FIG. 4. The method for measuring the depth of field comprises steps S1˜S4. The steps S1˜S4 will be described in more details as follows.

When the image pickup device 1 is ready to shoot a scene, the step S1 is performed. In the step S1, the sensing element 12 of the image pickup device 1 captures an image 2. The image 2 is composed of plural imaging areas. Each imaging area contains at least one pixel. For clarification, only one imaging area 21 of these imaging areas is marked in the image 2 of FIG. 5. Since the sensing element 12 comprises plural phase detection unit groups 121, the acquired image 2 contains plural phase detection pixel groups 22 corresponding to the plural phase detection unit groups 121. As shown in FIG. 5, each phase detection pixel group 22 comprises a first incident light portion 221 corresponding to the first incident light phase detection unit 1211 and a second incident light portion 222 corresponding to the second incident light phase detection unit 1212.

In this embodiment, the first incident light portion 221 is an upper incident light portion, and the second incident light portion 222 is a lower incident light portion. Moreover, the first incident light portion 221 and the second incident light portion 222 are included in the same pixel. It is noted that numerous modifications and alterations may be made while retaining the teachings of the invention. For example, in another embodiment, the first incident light portion 221 is a left incident light portion, and the second incident light portion 222 is a right incident light portion. Alternatively, the first incident light portion 221 and the second incident light portion 222 are included in different pixels.

In the step S2, the image 2 from the sensing element 12 is received by the image segmentation unit 13. The image segmentation unit 13 collects the plural first incident light portions 221 of the image 2 as a first pattern 31 and collects the plural second incident light portions 222 of the image 2 as a second pattern 32. The first pattern 31 and the second pattern 32 are shown in FIGS. 6A and 6B, respectively. Moreover, the first pattern 31 has plural first blocks 311 corresponding to the plural imaging areas of the image 2, and the second pattern 32 has plural second blocks 321 corresponding to the plural imaging areas of the image 2. For clarification, only one first block 311 of the plural first blocks corresponding to the imaging area 21 of FIG. 5 is marked in the first pattern 31 of FIG. 6A, and only one second block 321 of the plural second blocks 321 corresponding to the imaging area 21 of FIG. 5 is marked in the second pattern 32 of FIG. 6B.

In the step S3, the first pattern 31 and the second pattern 32 from the image segmentation unit 13 are received by the computing unit 14. The computing unit 14 acquires the phase difference between each first block and the corresponding second block, and acquires the phase differences between the each first block and plural test blocks. Then, a local depth-of-field data of the imaging area of the image 2 corresponding to the lowest phase difference of these phase differences is acquired. The plural test blocks are partially overlapped with the corresponding second blocks or located near the corresponding second blocks.

Hereinafter, the operating principles of the present invention will be illustrated with reference to the imaging area 21 of FIG. 5, the first block 311 of FIG. 6A and the second block 321 of FIG. 6B. The computing unit 14 acquires the phase difference E₁ between the first block 311 and the second block 321, and acquires the phase differences E₂₁, E₂₂, . . . , E₂ₘ, E₃₁, E₃₂, . . . , E₃ₙ between the first block 311 and plural test blocks 322₁, 322₂, . . . , 322ₘ, 323₁, 323₂, . . . , 323ₙ. The plural test blocks 322₁, 322₂, . . . , 322ₘ, 323₁, 323₂, . . . , 323ₙ are partially overlapped with the corresponding second block 321 or located near the corresponding second block 321 along a horizontal direction.

In this embodiment, the center positions P₂₁, P₂₂, . . . , P₂ₘ of the test blocks 322₁, 322₂, . . . , 322ₘ of the plural test blocks 322₁, 322₂, . . . , 322ₘ, 323₁, 323₂, . . . , 323ₘ are located at the left side of the center position P₁ of the second block 321, and the center positions P₃₁, P₃₂, . . . , P₃ₘ of the test blocks 323₁, 323₂, . . . , 323ₘ of the plural test blocks 322₁, 322₂, . . . , 322ₘ, 323₁, 323₂, . . . , 323ₙ are located at the right side of the center position P₁ of the second block 321. The second block 321 and the plural test blocks 322₁, 322₂, . . . , 322ₘ, 323₁, 323₂, . . . , 323ₙ have the same size. The selections of the plural test blocks 322₁, 322₂, . . . , 322ₘ, 323₁, 323₂, . . . , 323ₙ are presented herein for purpose of illustration and description only. It is noted that the selections of the plural test blocks may be varied according to the practical requirements. For example, in another embodiment, the plural test blocks are partially overlapped with the corresponding second block or located near the corresponding second block along a vertical direction.

Generally, the focused area of the image 2 is associated with the depth of field of the image. In case that the imaging area 21 of the image 2 is the focused area, the phase difference E₁ between the first block 311 and the second block 321 is zero or very small. Whereas, in case that the phase difference E₁ between the first block 311 and the second block 321 is not equal to zero or doesn't approach to zero, the imaging area 21 of the image 2 is not the focused area. Then, among the phase difference between the second blocks 321 and the first block 311 and the phase differences between the and the plural test blocks 322₁, 322₂, . . . , 322ₘ, 323₁, 323₂, . . . , 323ₙ and the first block 311, the lowest phase difference is selected. The imaging area 21 of the image 2 corresponding to the lowest phase difference indicates the focused area. Then, a local depth-of-field data of the imaging area 21 is acquired.

In this embodiment, the local depth-of-field data is expressed by −m, . . . , −2, −1, 0, 1, 2, . . . , n. For example, if the phase difference between the first block 311 and the test block 322ₘ is the lowest, the local depth-of-field data of the imaging area 21 is −m. Moreover, if the phase difference between the first block 311 and the test block 322₂ is the lowest, the local depth-of-field data of the imaging area 21 is −2. Moreover, if the phase difference between the first block 311 and the second block 321 is the lowest, the local depth-of-field data of the imaging area 21 is 0. Moreover, if the phase difference between the first block 311 and the test block 323₁ is the lowest, the local depth-of-field data of the imaging area 21 is 1. Moreover, if the phase difference between the first block 311 and the test block 323ₙ is the lowest, the local depth-of-field data of the imaging area 21 is n. If the phase difference between the first block 311 and another test block is the lowest, the rest of the local depth-of-field data of the imaging area 21 may be deduced by analogy. It is noted that the way of expressing the local depth-of-field data is not restricted.

In this embodiment, the phase difference E₁ between the first block 311 and the second block 321 and the phase differences E₂₁, E₂₂, . . . , E₂ₘ, E₃₁, E₃₂, . . . , E₃ₙ between the first block 311 and plural test blocks 322₁, 322₂, . . . , 322ₘ, 323₁, 323₂, . . . , 323ₙ are obtained by calculating peak signal-to-noise ratios (PSNR). Generally, the peak signal-to-noise ratio is an objective standard of evaluating the similarity of two patterns. A higher peak signal-to-noise ratio indicates a smaller phase difference. The relationship between the peak signal-to-noise ratio and the phase difference is well known to those skilled in the art, and is not redundantly described herein.

It is noted that the standard of evaluating the phase difference is not restricted to the peak signal-to-noise ratio. That is, the standard of evaluating the phase difference may be varied according to the practical requirements. In another embodiment, the phase difference E₁ between the first block 311 and the second block 321 and the phase differences E₂₁, E₂₂, . . . , E₂ₘ, E₃₁, E₃₂, . . . , E₃ₙ between the first block 311 and plural test blocks 322₁, 322₂, . . . , 322ₘ, 323₁, 323₂, . . . , 323ₙ are obtained by a zero mean normalized cross correlation (ZNCC) method. The ZNCC method is well known to those skilled in the art, and is not redundantly described herein.

After the phase difference E₁ between the first block 311 and the second block 321 and the phase differences E₂₁, E₂₂, . . . , E₂ₘ, E₃₁, E₃₂, . . . , E₃ₙ between the first block 311 and plural test blocks 322₁, 322₂, . . . , 322ₘ, 323₁, 323₂, . . . , 323ₙ are acquired by calculating the peak signal-to-noise ratios (PSNR) or using the ZNCC method, the computing unit 14 acquires the lowest phase different among these phase differences E₁, E₂₁, E₂₂, . . . , E₂ₘ, E₃₁, E₃₂, . . . , E₃ₙ. According to the lowest phase difference, the local depth-of-field data of the imaging area 21 of the image 2 is obtained.

Similarly, the local depth-of-field data of any other imaging area 21 of the image 2 can be obtained according to the above method through the relationship between the first block of the first pattern 31 and the image area and the relationship between the second block of the second pattern 32 and the image area.

Afterwards, in the step S4, the plural local depth-of-field data obtained in the step S4 are combined as an overall depth-of-field data of the image 2 by the computing unit 14.

From the above descriptions, the present invention provides an image pickup device and a method for measuring a depth of field. In accordance with the present invention, only one optical lens module is used to capture images. Moreover, the local depth-of-field data of each imaging area of the image is obtained according to plural first incident light portions and plural second incident light portions of the image. Then, the plural local depth-of-field data are combined as an overall depth-of-field data of the image. Since it is not necessary to install an additional optical lens module, the fabricating cost of the image pickup device is reduced. Moreover, the image pickup device can meet the requirements of small size, light weightiness and easy portability.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A method for measuring a depth of field, the method comprising steps of:
(a) capturing an image, wherein the image contains plural phase detection pixel groups, wherein the plural phase detection pixel groups comprise plural first incident light portions and plural second incident light portions, respectively;
(b) collecting the plural first incident light portions as a first pattern, and collecting the plural second incident light portions as a second pattern, wherein the first pattern has plural first blocks corresponding to plural imaging areas of the image, and the second pattern has plural second blocks corresponding to the plural imaging areas of the image;
(c) acquiring a phase difference between each first block and the corresponding second block and phase differences between the first block and plural test blocks, and acquiring a local depth-of-field data of the imaging area of the image corresponding to the lowest phase difference of the plural phase differences, wherein the plural test blocks are partially overlapped with the corresponding second block or located near the corresponding second block; and
(d) allowing the plural local depth-of-field data to be combined as an overall depth-of-field data of the image.

2. The method according to claim 1, wherein the plural phase differences are obtained by calculating peak signal-to-noise ratios.

3. The method according to claim 1, wherein the plural phase differences are obtained by a zero mean normalized cross correlation (ZNCC) method.

4. The method according to claim 1, wherein the plural test blocks are partially overlapped with the corresponding second block or located near the corresponding second block along a horizontal direction, or the plural test blocks are partially overlapped with the corresponding second block or located near the corresponding second block along a vertical direction.

5. The method according to claim 1, wherein the plural test blocks and the corresponding second block have the same size.

6. The method according to claim 1, wherein each imaging area contains at least one pixel.

7. The method according to claim 1, wherein the first incident light portion and the second incident light portion are respectively an upper incident light portion and a lower incident light portion, or the first incident light portion and the second incident light portion are respectively a left incident light portion and a right incident light portion.

8. An image pickup device, comprising:
an optical lens module;
a sensing element, wherein after light beams passing through the optical lens module are projected on the sensing element, the sensing element senses the light beams and acquires an image, wherein the sensing element comprises plural phase detection unit groups, and the image contains plural phase detection pixel groups corresponding to the plural phase detection unit groups, wherein the plural phase detection pixel groups comprise plural first incident light portions and plural second incident light portions, respectively;
an image segmentation unit connected with the sensing element, wherein the image segmentation unit collects the plural first incident light portions as a first pattern and collects the plural second incident light portions as a second pattern, wherein the first pattern has plural first blocks corresponding to plural imaging areas of the image, and the second pattern has plural second blocks corresponding to the plural imaging areas of the image; and
a computing unit connected with the image segmentation unit, wherein the computing unit acquires a phase difference between each first block and the corresponding second block and phase differences between the first block and plural test blocks, acquires a local depth-of-field data of the imaging area of the image corresponding to the lowest phase difference of the plural phase differences, and combines the plural local depth-of-field data as an overall depth-of-field data of the image,
wherein the plural test blocks are partially overlapped with the corresponding second block or located near the corresponding second block.

9. The image pickup device according to claim 8, wherein the plural phase differences are obtained by calculating peak signal-to-noise ratios.

10. The image pickup device according to claim 8, wherein the plural phase differences are obtained by a zero mean normalized cross correlation (ZNCC) method.

11. The image pickup device according to claim 8, wherein the plural test blocks are partially overlapped with the corresponding second block or located near the corresponding second block along a horizontal direction, or the plural test blocks are partially overlapped with the corresponding second block or located near the corresponding second block along a vertical direction.

12. The image pickup device according to claim 8, wherein the plural test blocks and the corresponding second block have the same size.

13. The image pickup device according to claim 8, wherein each imaging area contains at least one pixel.

14. The image pickup device according to claim 8, wherein the first incident light portion and the second incident light portion are respectively an upper incident light portion and a lower incident light portion, or the first incident light portion and the second incident light portion are respectively a left incident light portion and a right incident light portion.
